(19) United States
(12) Patent Application Publication
(10) Pub. No.: US 2026/0343683 A1
(43) Pub. Date: Oct. 29, 2026

(54) HEAT MEDIUM HEATING DEVICE

(71) Applicant: SANDEN CORPORATION, Gunma (JP)

(72) Inventors: Masafumi MURAKAMI, Gunma (JP); Shinichi MASUDA, Gunma (JP); Atsushi HOMMA, Gunma (JP)

(21) Appl. No.: 19/107,302

(22) PCT Filed: Aug. 29, 2023
(86) PCT No.: PCT/JP2023/031304

§ 371 Date: Feb. 27, 2025

(30) Foreign Application Priority Data
Sep. 26, 2022 (JP) 2022-152463

(51) Int. Cl. H05B 3/42; F24H 9/18

(52) U.S. Cl. CPC H05B 3/42; F24H 9/18

(57) ABSTRACT

A heat medium heating device includes: a plurality of rod-shaped heating elements arranged in parallel with each other; and a housing in which the plurality of rod-shaped heating elements is accommodated, in which the housing includes a plurality of heating channels that circulates a heat medium along the rod-shaped heating element and a communication channel that communicates the plurality of heating channels, and the communication channel includes a channel widening portion that widens a channel width of the heat medium on a side opposite to an extending direction of the heating channel.

### TECHNICAL FIELD

The present invention relates to a heat medium heating device.

### BACKGROUND ART

Heretofore, in a heat medium heating device used for vehicle air conditioning or the like, a heating channel that circulates the heat medium along a heating element is formed in a housing in which a rod-shaped heating element is accommodated. In the housing in which a plurality of heating elements is accommodated, a plurality of heating channels is formed along the plurality of heating elements arranged in parallel with each other, and a communication channel that communicates the plurality of heating channels is formed, and a heat medium flowing in from the inlet of the housing is heated to a predetermined temperature while reaching the outlet of the housing via the plurality of heating channels and the communication channel (see, for example, Patent Literature 1.)

### CITATION LIST

### Patent Literature

Patent Literature 1: JP-T-2016-536197

### SUMMARY OF INVENTION

### Problems to be Solved by Invention

In the background-art heat medium heating device described above, the plurality of rod-shaped heating elements is arranged in parallel with each other, and a communication channel is formed in a direction orthogonal to the linear heating channels arranged in parallel with each other. For this reason, there is a problem that the flow of the heat medium from the heating channel toward the communication channel is rapidly changed in a direction to increase the flow resistance, and the flow of the heat medium in the plurality of heating channels sandwiching the communication channel becomes non-uniform.

The present invention has been proposed to address such a problem. That is, in the heat medium heating device in which the plurality of rod-shaped heating elements is accommodated in the housing, it is an object of the present invention to improve the flow resistance of the plurality of heating channels arranged in parallel with each other along the rod-shaped heating element and the communication channel that communicates the plurality of heating channels and to eliminate the non-uniformity of the flow of the heat medium in the plurality of heating channels.

### Solution to Problems

In order to solve such a problem, the heat medium heating device according to the present invention has the following configuration.

A heat medium heating device includes: a plurality of rod-shaped heating elements arranged in parallel with each other; and a housing in which the plurality of rod-shaped heating elements is accommodated, in which the housing includes a plurality of heating channels that circulates a heat medium along the rod-shaped heating element and a communication channel that communicates the plurality of heating channels, and the communication channel includes a channel widening portion that widens a channel width of the heat medium on a side opposite to an extending direction of the heating channel.

### Effects of Invention

According to the present invention having such a characteristic, it is possible to improve the heating efficiency of the heat medium heating device by improving the flow resistance of the plurality of heating channels arranged in parallel with each other along the rod-shaped heating elements and the communication channel that communicates the plurality of heating channels and eliminating the non-uniformity of the flow of the heat medium in the plurality of heating channels.

### BRIEF DESCRIPTION OF DRAWINGS

FIG. 1 is an external view of a heat medium heating device.

FIG. 2 is a cross-sectional view of the heat medium heating device.

FIG. 3 is a diagram showing a flow of a heat medium in the heat medium heating device.

FIG. 4 is a diagram showing a seal portion of a second housing portion.

### DESCRIPTION OF EMBODIMENTS

In the following, an embodiment of the present invention will be described with reference to the drawings. In the following description, the same reference numerals in different drawings indicate parts having the same function, and redundant description in the respective drawings is appropriately omitted.

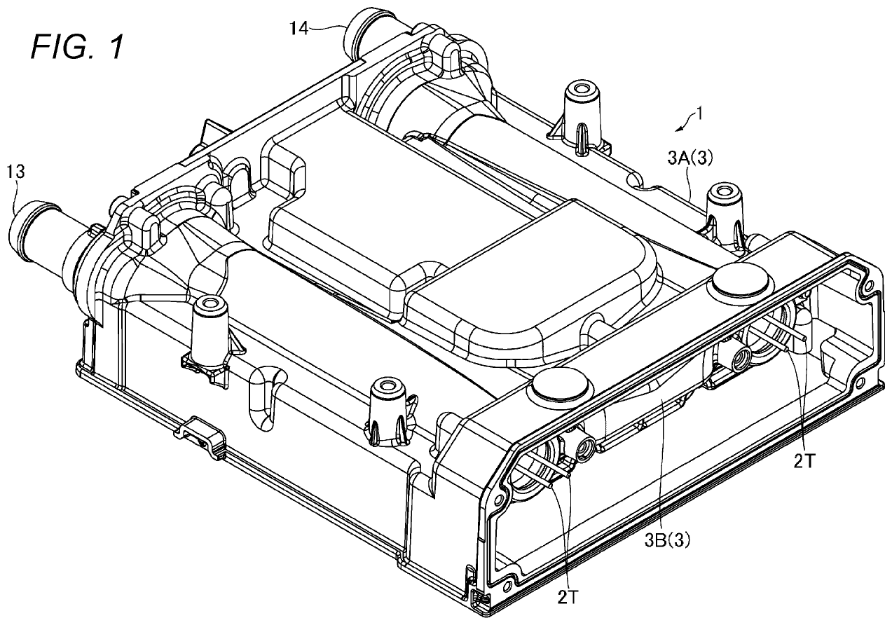

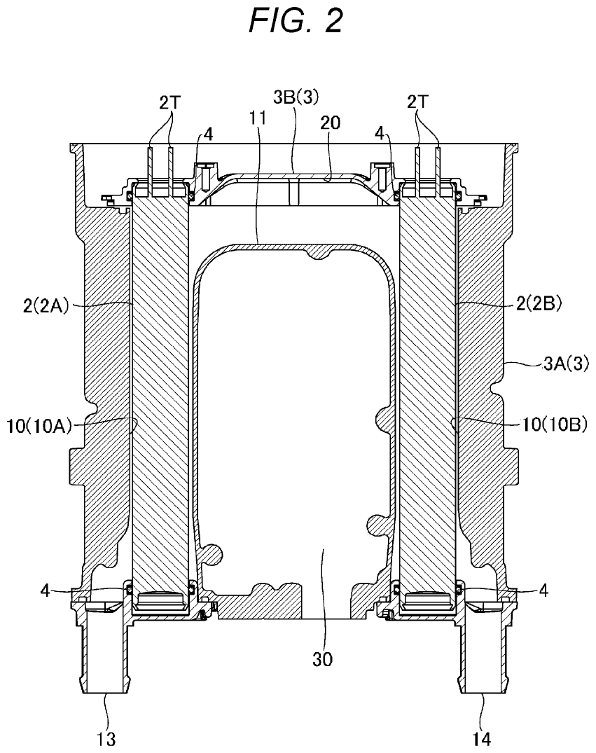

As shown in FIGS. 1 and 2, a heat medium heating device I includes a plurality of rod-shaped heating elements 2 (2A, 2B) and a housing 3. The plurality of rod-shaped heating elements 2 (2A, 2B) is accommodated in the housing 3, and in the housing 3, a heating channel 10 (10A, 10B) that circulates a heat medium along the rod-shaped heating element 2 (2A, 2B) is formed around the rod-shaped heating element 2 (2A, 2B). In addition, a communication channel 11 that communicates a plurality of the heating channels 10 (10A, 10B) is formed in the housing 3.

In the rod-shaped heating element 2 (2A, 2B), a terminal portion 2T is provided on one end side, and the terminal portion 2T is connected to a control board (not shown) via a connection wiring (bus bar). Both ends of the rod-shaped heating element 2 (2A, 2B) are supported in the housing 3 via seal members (O-rings or the like) 4.

The plurality of rod-shaped heating elements 2 (2A, 2B) is arranged in parallel with each other in the housing 3. In the housing 3, a linear accommodation space that accommodates the plurality of rod-shaped heating elements 2 (2A, 2B) is formed, and a gap formed around the rod-shaped heating element 2 (2A, 2B) in a state where the rod-shaped heating element 2 (2A, 2B) is accommodated in the accommodation space becomes the heating channel 10 (10A, 10B) of the heat medium.

In the shown example, the housing 3 is provided with an inflow portion 13 and an outflow portion 14 of the heat medium on the opposite side of the terminal portion 2T in the rod-shaped heating element 2 (2A, 2B). The inflow portion 13 communicates with the heating channel 10 (10A) accommodating one rod-shaped heating element 2 (2A), and the outflow portion 14 communicates with the heating channel 10 (10B) accommodating another rod-shaped heating element 2 (2B). The heat medium flowing in from the inflow portion 13 of the housing 3 is heated while passing through one heating channel 10 (10A) in which the rod-shaped heating element 2 (2A) is accommodated, flows through the communication channel 11, is further heated while passing through another heating channel 10 (10B) in which the rod-shaped heating element 2 (2B) is accommodated, and reaches the outflow portion 14.

In the housing 3, a circuit component accommodating portion 30 is formed between the plurality of heating channels 10 (10A, 10B) arranged in parallel with each other. The circuit component accommodating portion 30 accommodates circuit components and the like connected to the control board (not shown).

The housing 3 includes a first housing portion 3A and a second housing portion 3B. In the first housing portion 3A, a communication channel 11 is formed with the above-described plurality of heating channels 10 (10A, 10B), the inflow portion 10 and the outflow portion 14 are formed, and the circuit component accommodating portion 30 is further provided. On the other hand, the second housing portion 3B is provided with the channel widening portion 20 that widens the channel of the communication channel 11.

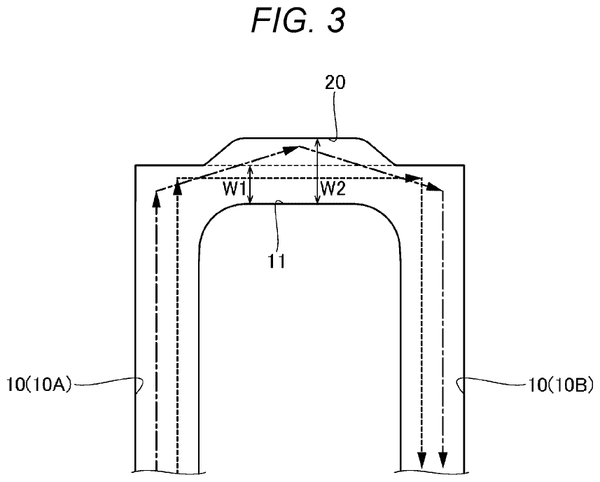

As shown in FIG. 3, the channel widening portion 20 added to the communication channel 11 by the second housing portion 3B widens the channel width of the heat medium in the direction opposite to the extending direction of the heating channel 10 (10A, 10B). In the shown example, when the channel widening portion 20 is not provided, the channel width of the communication channel 11 along the extending direction of the heating channel 10 (10A, 10B) is W1. However, by adding the channel widening portion 20 by the second housing portion 3B, the channel width of the communication channel 11 along the extending direction of the heating channel 10 (10A, 10B) is widened to W2 (>W1). In other words, the channel widening portion 20 widens the channel width along the extending direction of the heating channel 10 (10A, 10B) in the communication channel 11 to the side opposite to the extending direction of the heating channel 10 (10A, 10B) by (W2−W1).

In FIG. 3, the flow of the heat medium from one heating channel 10 (10A) to the other heating channel 10 (10B) through the communication channel 11 will be described. When the channel widening portion 20 is not provided, the channel direction of the heat medium is changed substantially at a right angle as indicated by a broken line in the drawing, and there is a problem that the flow resistance increases due to the rapid change in the channel direction.

On the other hand, when the channel widening portion 20 is added, the flow of the heat medium is as indicated by an alternate long and short dash line in the drawing, and the channel widening portion 20 forms the channel of the heat medium in a direction intersecting at an obtuse angle with respect to the extending direction of the heating channel 10 (10A, 10B). As a result, in the flow of the heat medium from one heating channel 10 (10A) to the other heating channel 10 (10B) through the communication channel 11, the rapid change in the channel direction is alleviated, and the flow resistance is improved.

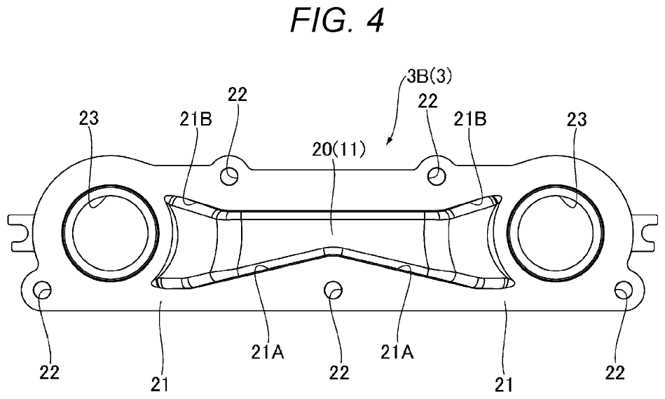

As shown in FIG. 4, the second housing portion 3B can be formed of a single component, and is closely bonded to the first housing portion 3A to seal the terminal portion 2T side of the rod-shaped heating element 2 (2A, 2B) in the heating channel 10 (10A, 10B) and additionally form the channel widening portion 20 in the communication channel 11. For this reason, the second housing portion 3B includes a seal portion 21 that surrounds the terminal portions 2T of the plurality of rod-shaped heating elements 2 (2A, 2B) and is in close contact with the first housing portion 3A on both outer sides of the communication channel 11 in the flow direction.

FIG. 4 shows a planar configuration of the seal portion 21 of the second housing portion 3B. The seal portion 21 is provided with inclined portions 21A and 21B having a seal width increasing toward the center of the channel widening portion 20 at an inner edge along the communication channel 11. The inclined portion 21A provided on one side of both outer sides of the communication channel 11 in the flow direction is longer than the inclined portion 21B provided on the other side. In addition, terminal portion insertion holes 23 through which the terminal portions 2T of the rod-shaped heating elements 2 (2A, 2B) are inserted are provided at both ends of the seal portion 21.

The inclined portions 21A and 21B provided in the seal portion 21 are formed to provide fastening holes 22 in the seal surface of the seal portion 21. The fastening hole 22 is a hole into which a fastening member is inserted when the second housing portion 3B is joined to the first housing portion 3A. As described above, by forming the inclined portion 21 A longer than the inclined portion 21B, it is possible to perform three-point fastening in which one fastening hole 22 is provided on the inclined portion 21A side and two fastening holes 22 are provided on the inclined portion 21B side. In this manner, by making the inclination on the inclined portion 21A side long and gentle by three-point fastening, it is possible to suppress the flow resistance in the channel widening portion 20 formed by the second housing portion 3B while securing the sealability of the seal portion 21.

As described above, according to the heat medium heating device 1 of the embodiment according to the present invention, by providing the channel widening portion 20 that widens the channel width of the heat medium on the opposite side to the extending direction of the heating channel 10 (10A, 10B) in the communication channel 11 that communicates the heating channels 10 (10A, 10B) arranged in parallel with each other along the rod-shaped heating element 2 (2A, 2A), it is possible to improve the flow resistance of the flow of the heat medium from one heating channel 10 (10A) to the other heating channel 10 (10B) through the communication channel 11. By improving the flow resistance, non-uniformity of the flow of the heat medium in the plurality of heating channels 10 (10A, 10B) is eliminated, and it is possible to improve the heating efficiency of the heat medium heating device 1 by the uniform flow of the heat medium flowing through the heating channels 10 (10A, 10B).

As described so far, the embodiment of the present invention have been described in detail with reference to the drawings. However, the specific configuration is not limited to the embodiment, and, for example, modifications to the design within the scope that does not deviate from the gist of the present invention are also included in the present invention. In addition, each of the foregoing embodiments can be combined by diverting their techniques as long as there is no particular contradiction or problem in the purpose, configuration, and the like.

### LIST OF REFERENCE SIGNS

1 Heat medium heating device
2, 2A, 2B Rod-shaped heating element
2T Terminal portion
3 Housing
3A First housing portion
3B Second housing portion
4 Seal member
10, 10A, 10B Heating channel
11 Communication channel
13 Inflow portion
14 Outflow portion
20 Channel widening portion
21 Seal portion
21A, 21B Inclined portion
22 Fastening hole
23 Terminal portion insertion hole
30 Circuit component accommodating portion

1. A heat medium heating device comprising: a plurality of rod-shaped heating elements arranged in parallel with each other; and a housing in which the plurality of rod-shaped heating elements is accommodated, wherein the housing includes a plurality of heating channels that circulates a heat medium along the rod-shaped heating element and a communication channel that communicates the plurality of heating channels, wherein
the communication channel includes a channel widening portion that widens a channel width of the heat medium on a side opposite to an extending direction of the heating channel.

2. The heat medium heating device according to claim 1, wherein the channel widening portion forms a channel of the heat medium in a direction intersecting at an obtuse angle with respect to an extending direction of the heating channel.

3. The heat medium heating device according to claim 1, wherein the housing includes: a first housing portion in which the plurality of heating channels and the communication channel that allows ends of the heating channels to communicate with each other are formed; and a second housing portion that adds the channel widening portion to the communication channel.

4. The heat medium heating device according to claim 3, wherein the second housing portion includes a seal portion that surrounds terminal portions of the plurality of rod-shaped heating elements and is in close contact with the first housing portion on both outer sides in a flow direction in the communication channel.

5. The heat medium heating device according to claim 4, wherein the seal portion is provided with an inclined portion having a seal width increasing toward a center of the channel widening portion at an inner edge along the communication channel, and the inclined portion provided on one side of both outer sides in the flow direction of the communication channel is longer than the inclined portion provided on the other side.
